(19) United States
(12) Patent Application Publication
(10) Pub. No.: US 2010/0057822 A1
(43) Pub. Date: Mar. 4, 2010

(54) INVERSE TRANSFORMATION LOADING

(75) Inventors: Dragos A. Manolescu, Kirkland, WA (US); John Wesley Dyer, Monroe, WA (US); Henricus Johannes Maria Meijer, Mercer Island, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/198,971

(22) Filed: Aug. 27, 2008

(51) Int. Cl. G06F 17/14; H04L 9/00

(52) U.S. Cl. 708/400; 380/255

(57) ABSTRACT

An inverse transformation and/or identification thereof is transmitted to a receiver to enable interpretation of transformed data. Rather than requiring installation of a transform on a sender and an inverse transform on a receiver prior to communication, an appropriate inverse transformation can be provided to and executed by a receiving component as needed. In accordance with one aspect, a transformation and associated inverse are selected dynamically as a function of context to minimize or maximize some parameter, for instance.

### BACKGROUND

Distributed systems comprise processing nodes and communication channels. Various distributed system architectures exist including client/server, N-tiered, and peer-to-peer, amongst others. In order to enable a variety of processing nodes to operate within such a system, standard communication channels and protocols are employed. In the context of web applications, for example, one of the processing nodes represents the browser and other processing nodes are web servers. Further, communication channels in the web application context typically employ Transmission Control Protocol (TCP), using HyperText Transfer Protocol (HTTP) or a secured version thereof (HTTPS).

Distributed systems employ transformations to adapt to the characteristics of communication channels and/or achieve desired characteristics. For example, serialization/deserialization transforms data exchanged between participants in a manner that makes it compatible with a communication channel. Similarly, other transformations such as compression or encryption can be employed to transform data such that it requires fewer symbols, or make it hard for a third party to extract confidential information. Yet other transformations add error-correcting codes to increase resilience to channel noise, and so forth.

Channel and other transformations require a direct transformation “F” on the sending side, and an inverse transformation “F⁻¹” on the receiving side. Math dictates that composing these transformations yields the identity function. Consequently, after applying these transformations in sequence, the original message sent from the sender over a communication channel becomes available to the receiver.

The requirement that the sender and receiver host direct transformations and inverse transformations couples them tightly. In particular, such transformation pairs typically require hardcoded installation on each of the sender and receiver and/or require outside intervention. Accordingly, should one desire to change a transformation both the sender and receiver need to install new code to capture respective portions of the transformation. For example, if employment of a new serializer is desired, serialization code needs to be installed on the sending side and matching deserialization code should be installed on the receiving side. In other words, changing a transformation impacts both ends of a channel.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to data transformations amongst communication nodes. More specifically, rather than requiring hardcoded installation of a direct transformation and inverse transformation on a sender and receiver, respectively and/or outside intervention, the inverse transformation can be provided to the receiver by the sender for recovering a message sent by the sender over a communication channel(s). In this case, the receiver need only be able to apply an inverse transformation to incoming data. Furthermore and in accordance with an aspect of the disclosure, transformation and inverse transformation pairs can be changed dynamically as a function of context. Accordingly, communication protocol between a sender and receiver can automatically adapt to changing circumstances in furtherance of some goal, for instance.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a distributed system that employs inverse transformation loading according to an aspect of the subject disclosure.

FIG. 2 is a graphical illustration of transformation with respect to senders and receivers to facilitate clarity and understanding with respect to aspects of the disclosure.

FIG. 3a is a block diagram of a compositional transformation process according to an aspect of the disclosed subject matter.

FIG. 3b is a block diagram of a compositional inverse transformation according to a disclosed aspect.

FIG. 3c is a block diagram of application of a compositional inverse transformation to removed data transformations.

FIG. 4 is a block diagram of a representative sender system in accordance with an aspect of the disclosure.

FIG. 5 is a block diagram of a representative receiver system according to a disclosed aspect.

FIG. 6 is a block diagram of an interpreter update system in accordance with an aspect of the disclosure.

FIG. 7 is a block diagram of a three party communication system according an aspect of the subject disclosure.

FIG. 8 is a flow chart diagram of a method of communication in accordance with an aspect of the disclosure.

FIG. 9 is a flow chart diagram of a method of sending data according to a disclosed aspect.

FIG. 10 is a flow chart diagram of a method of receiving data in accordance with an aspect of the disclosure.

FIG. 11 is a flow chart diagram of a method of sender/receiver interaction according to an aspect of the disclosure.

FIG. 12 is a schematic block diagram illustrating a suitable operating environment for aspects of the subject disclosure.

FIG. 13 is a schematic block diagram of a sample-computing environment.

### DETAILED DESCRIPTION

Systems and methods pertaining to inverse transformation loading are disclosed in detail hereinafter. Conventionally, transformation code associated with distributed systems is programmed into a sender and receiver prior to data transmission. Here, however, the sender transforms data and affords an inverse transformation associated with the data to the receiver, which applies the inverse to the data to remove the transformation and make the data available. Additionally or alternatively, the sender can identify a common transformation/inverse for employment. Further, transformation can comprise a series of transformations (e.g., serialization/deserialization, encryption/decryption, compression/decompression . . . ). Furthermore, one or more transformations are selected and employed dynamically as a function of context information. Accordingly, transformations can vary with changing circumstances. In a similar manner, a receiver-side interpreter or firmware can be replaced with an alternate implementation provisioned by a sender.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

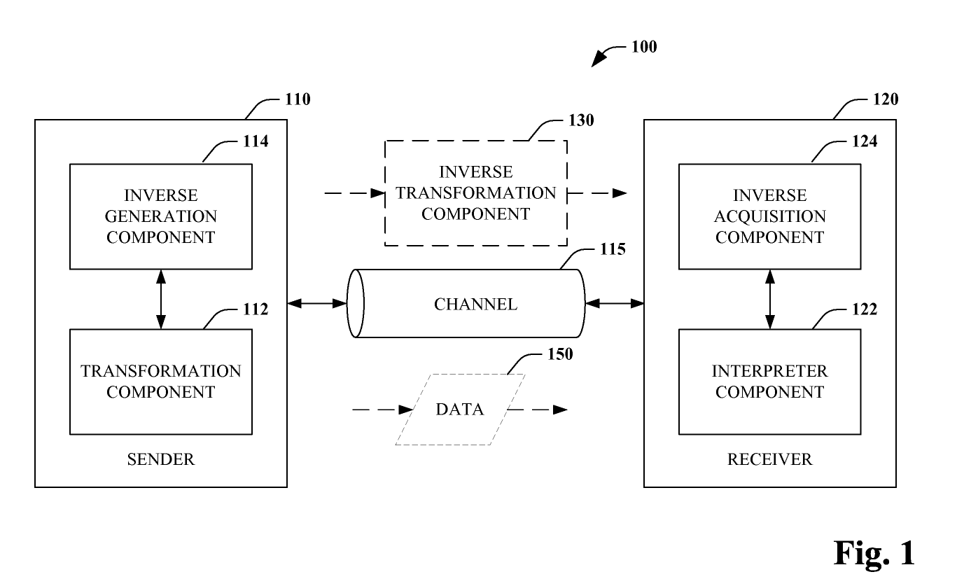

Referring initially to FIG. 1, a distributed system 100 is illustrated that employs inverse transformation loading in accordance with an aspect of the claimed subject matter. The system 100 includes a sender component 110, receiver component 120, and a channel component 115 to facilitate communication amongst the sender component 110 and receiver component 120. Together they enable data transformation by way of function and inverse function application. By way of example, such transformations can include serialization/deserialization, encryption/decryption, and/or compression/decompression, amongst others.

Conventionally, a requirement that senders and receivers host transformations and inverse transformations, respectively, couples the components tightly. For example, where a new serializer is desired to be employed, serialization code needs to be loaded on the sender and deserialization code needs to be installed on the receiver. In other words, changing a transformation affects both ends of a channel. It is to be noted that in a distributed system, both sides are not typically under control of the same organization, entity or the like. Consequently, it is extremely difficult if even possible to plug in new transformations. The problem is further compounded when there is a many-to-one or one-to-many relationship between the sender and receiver since the many end needs to be updated.

System 100 reduces the tight coupling conventionally associated with senders 110 and receivers 120. In particular, the system allows the sender component 110 to provision an inverse transformation to a receiver component 120. The receiver component 120 can then apply the loaded inverse transformation to data to remove a transformation. Consequently, the sender component 110 and receiver component 120 can be independent and/or isolated components. For example, the receiver component 120 need only be able to apply inverse transformations provided by a sender to received data, thereby making it available for use by the receiver component 120.

As shown, the sender component 110 includes a transformation component 112 and an inverse generation component 114. The transformation applies one or more transformations or functions to data for transmission such as but not limited to those related to serialization, encryption, and/or compression. The inverse generation component produces or identifies an inverse transformation component 130, which at least reverses a related transformation. For example, the transformation can correspond to a function “F” and the inverse transformation component 130 can correspond to the inverse of “F” or “F⁻¹”, composed they yield the identity function. More specifically, the inverse transformation component 130 can represent instructions for implementing “F⁻¹”. However, where the sender component 110 and receiver component 120 operate in different execution environments or contexts, the inverse transformation function can be a semantically equivalent implementation thereof.

The receiver component 120 acquires data 150 and an inverse transformation component 130 from the communication channel 115. The receiver component 120 includes an inverse acquisition component 124 and an interpreter component 122 The inverse acquisition component 124 acquires, identifies, and/or otherwise detects the presence of the inverse transformation component 130 afforded by the sender component 110. By way of example and not limitation, the component 124 can identify instructions or code embodying the inverse transformation component 130 from a stream of data. In one instance, the acquisition can also reconstruct the inverse transformation, for example by deserializing a serialized form.

The interpreter component 122 provides an execution environment that applies an inverse transformation or function 130 to a data acquired by the receiver component 120 and more specifically the inverse acquisition component 124. Stated differently, the interpreter component 122 can implement instructions representing an inverse function to recover a message sent by the sender component 110 encoded with a corresponding direct transformation function. In accordance with one embodiment, the inverse transformation component 130 itself can be represented and transmitted as data. Additionally, upon receipt of an inverse transformation component 130, the interpreter component 122 is essentially reprogrammed. For example, a data stream can be interpreted in accordance with a first function until a second function is acquired at which time the second function is employed.

The channel component 130 (also known as a communication channel) includes any medium, mechanism or means for communicatively coupling a sender component 110 to a receiver component or vice versa. The channel 130 enables both wired and wireless communication among other things. Further, the actual embodiment or implementation can be dependent upon particular embodiments or implementations of the sender component 110 and/or receiver component 120.

In accordance with one embodiment, the system 100 can pertain to server-browser interaction. In particular, the sender component 110 can correspond to a server and the receiver component 120 can correspond to a client network or web browser. Accordingly, the channel component 130 can support network communication amongst the sender and receiver by way of a HTTP or HTTPS. However, the sender component 110 and the receiver component 120 can operate with respect to particular object implementation such as but not limited to JSON (JavaScript Object Notation) encoded objects. Accordingly, a serialization/deserializaiton transformation can be utilized to send JSON over HTTP at one end, and receive JSON over HTTP at the other end, for instance.

It is to be appreciated that while the sender component 110 can transmit an inverse transformation component 130 or representation thereof (e.g., instructions, code . . . ), it need not. In some situations, it may be desirous to employ a common or standard transformation (e.g., base64, ECMA-222 . . . ) that is known by a receiver. Rather than transmitting the entire transformation component 130 or representation, the sender can simply transmit identification of a transformation. The inverse acquisition component 124 could also detect identification of a transformation and facilitated execution of a corresponding inverse by the interpreter component 122. For example, the inverse acquisition component 124 could provide a pointer to local code that performs the inverse. In this manner, transformations can still be employed dynamically yet without incurring the expense of transmission of an entire inverse transformation across the channel component 115 when not necessary.

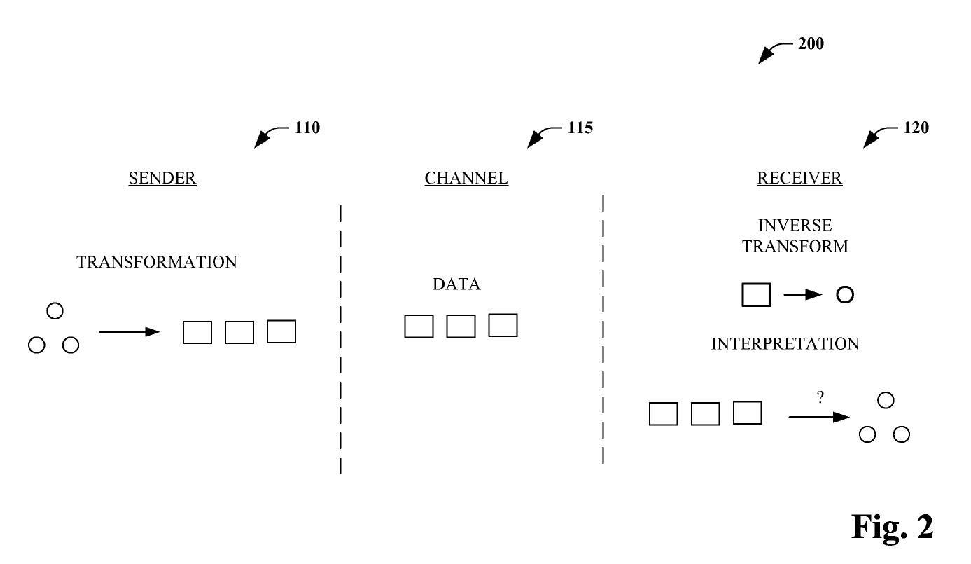

FIG. 2 depicts a graphical representation 200 of operation the system 100 of FIG. 1 to facilitate clarity and understanding with respect to aspects of the claimed subject matter. Continuing with a serialization example, the sender 110 and receiver can operate on set of organized circles while the communication channel 130 is capable of transferring sequences of squares. Accordingly, the sender 110 can perform a transformation from circles to squares and transmit the squares across the channel 130. Additionally, the sender component 110 can identify and transmit an inverse transformation or function to the receiver 120 across communication channel 115, represented as squares. Upon receipt of squares at the receiver side, it is unknown how to process the squares since the receiver operates on circles. However, the inverse transformation afforded by the sender can be employed by the receiver to transform the squares back into circles that it understands. It is to be appreciated that any transformation for which an inverse can be computed and applied can be employed in a similar manner. For instance, the squares could correspond to a compressed or encrypted version of data.

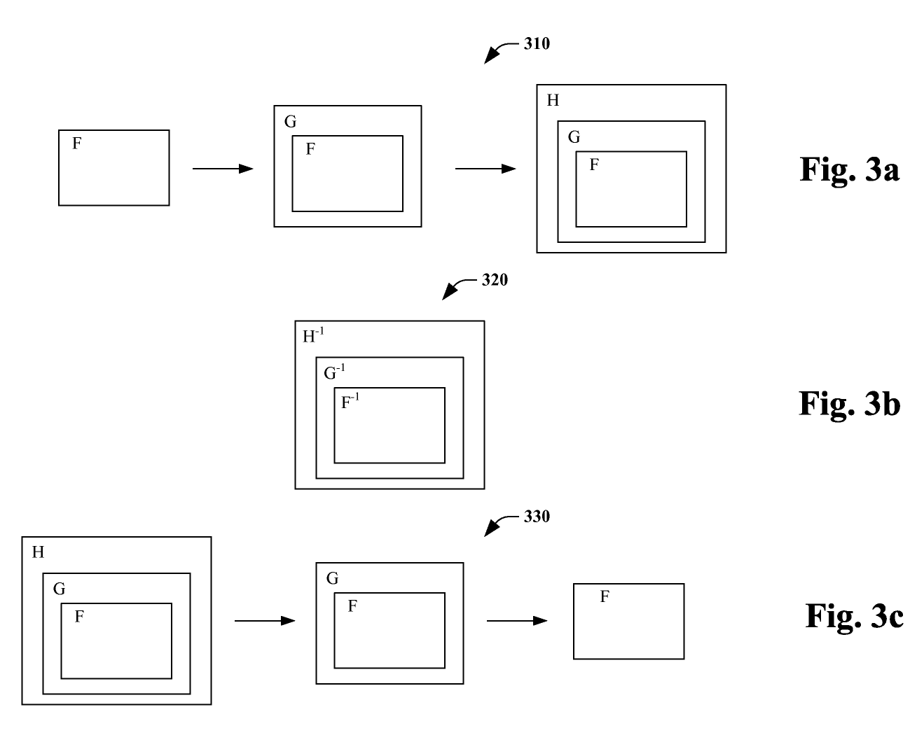

FIGS. 3a-c are block diagrams illustrating compositional transformations in accordance with an aspect of the claimed subject matter. A significant concept with respect to transformation is function application. A function can be applied at a sending side and the inverse of that function applied at the receiver side. Function application is composable. Therefore, transformations are composable. For example, data can be encrypted, compressed, and then serialized on one side and, and then inversely deserialized, decompressed, and decrypted on the other side.

FIG. 3a depicts a transformation process 310 that can be performed by a sender-side transformation component. Here, a function F is first applied to data, “F(x)”, where “x” is a data element. Subsequently, a function “G” is applied to “F(x)” forming “G(F(x))”. Finally, function “H” is applied to “G(F(x))” to produce “H(G(F(x))”. The inverse transformation or function 320 is composed similarly except utilizing inverse functions resulting in “H⁻¹(G⁻¹(F⁻¹(x)))”. On the receiver-side, the transformation 330 of FIG. 3c applies the inverse function 320 of FIG. 3b to remove the transformations one by one. In particular, the effects of each individual transformations are removed in reverse order, from which they were originally applied. Upon application of “H⁻¹” to “H(G(F(x))” the result is “G(F(x))” which can be transformed to “F(x)” upon application of “G⁻¹”. Finally, the original data is returned upon execution of inverse transformation “F⁻¹” of “F(x)”. Of course, a composition can include transmitted and/or identified transformations.

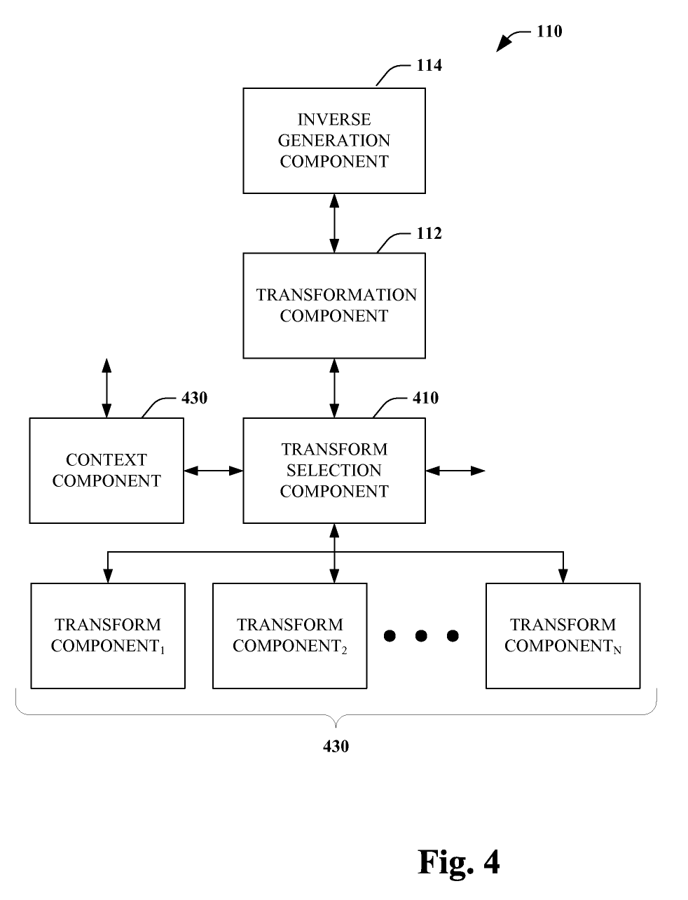

FIG. 4 illustrates a representative sender system 110 in accordance with an aspect of the claimed subject matter. Similar to system 100 of FIG. 1, the sender system 110 includes the transformation component 112 and inverse generation component 114, as previously described. In brief, the transformation component 112 identifies or generates and applies one or more transformations to data, and the inverse generation component 114 produces one or more inverse transformations that undo the applied transformations.

The system 110 also includes a transform selection component 410 communicatively coupled to a context component 420. The transform selection component 410 facilitates selection of one or more transform (also referred to as transformations) or function components 430 for application by the transformation component 112. While the transform components 420 can correspond to different types of transforms or functions such as serialization, decryption, and compression, the components 420 can also include different implementations of each type of transform. For example, there can be different compression transforms that compress data to more or less degrees. The transform selection component 410 can select an appropriate transformation based on a plurality of factors. In one instance, the transform selection component 410 can solicit context information from the context component 420 such as channel context (e.g., current bandwidth, channel properties (e.g., lossy, lossless) . . . ), receiver context (e.g., type, capabilities, operation mode (e.g., power conservation), load . . . ), data sensitivity, potential security threats, and/or user credentials, among other things. For example, the context component 420 and/or the transform selection component 410 can communicate with one or more receivers and corresponding communication channels to acquire information about the type of receiver, process capabilities, current state, etc., as well as the channel capabilities. Based on this and other information, the transform selection component 410 can determine or infer the best transform or transforms for a given situation. For example, certain parameters might be desired to be maximized or minimized. Furthermore, mismatch between a channel's capabilities and communication requirements represents one reason for employing transformations.

It should be noted and appreciated that while transform(s) can be selected initially, they can also be re-evaluated dynamically and adjusted based on changed circumstances. By way of example, consider a situation in which an encryption transformation or function is selected initially as a function of current state and then it is determined that receiver load is high and processing is slowing. In this case, if the data is within a threshold of sensitivity and potential for security threats are low, the sender can automatically switch to a less CPU-intensive encryption algorithm in an attempt expedite or otherwise facilitate receiver processing. Similarly, if it is determined or inferred that bandwidth is in high demand at particular times of the day, then a compression transformation can be applied when it might not be utilized at other times. In this way, communication protocol between a sender and receiver can be automatically adaptive to circumstances.

Furthermore, it should be appreciated that the transform selected via the transform selection component 410 can be affected by and/or interact with monetization and/or incentive scheme or system (not shown). For example, receivers or users of receivers can purchase rights or credentials to one or more transformations. In one instance, a user can purchase the right to use a more secure encryption transformation than a freely available default transformation. Subsequently, that transformation is available for selection and application. Of course, cash payment need to be required. Functionality can similarly be offered as an incentive to try a program or participate in a survey, among things.

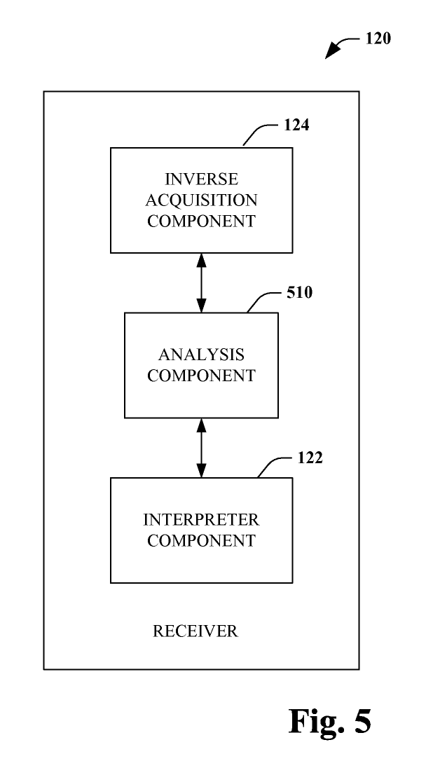

FIG. 5 is a block diagram of a representative receiver component 120 in accordance with an aspect of the claimed subject matter. Similar to receiver component 120 of FIG. 1, the receiver component 120 includes the inverse acquisition component 124 and the interpreter component 122, which interprets data in light of an acquired inverse transformation, as previously described. Additionally, the receiver component 120 can include analysis component 510 that evaluates acquired transformations prior to application. The analysis component 510 can identify malicious or otherwise undesirable aspects of an inverse transformation or something resembling such a transformation and prevent or advise against application by the interpreter component 122. Stated differently, rather than simply executing arbitrary inverse functions, the receiver utilizes analysis component 510 to inspect the instructions received from the sender and offer a degree of protection against malicious, unsafe, and/or undesirable actions. For example, where the analysis component 510 can determine or infer that an inverse function includes an infinite loop, the interpreter component 122 can be prevented from attempting to execute or apply the function. Moreover, transforms may be required to carry proofs of appropriate functionality or have certain properties that can be evaluated by analysis component 510 prior to execution or application by interpreter component 122.

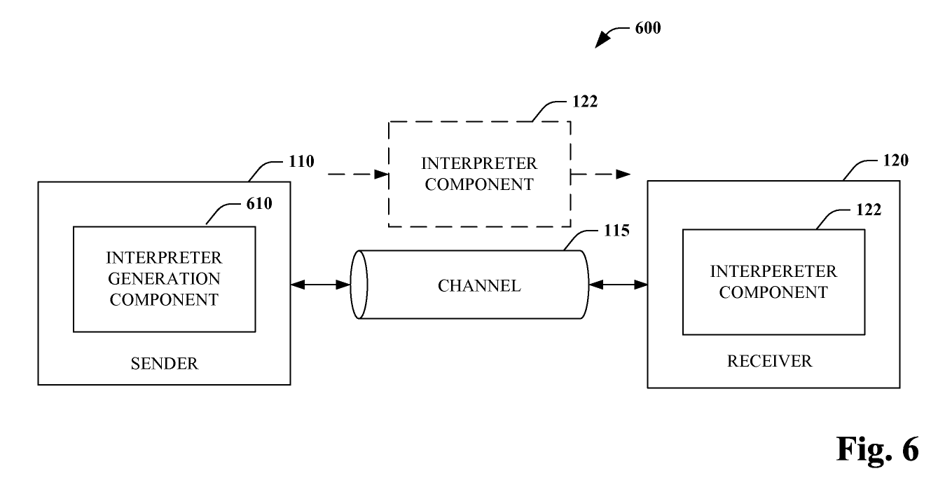

FIG. 6 is an interpreter update system 600 in accordance with an aspect of the claimed subject matter. The system 600 includes a sender component 110, communication channel 115, and receiver component 120, as previously described with respect to system 100 of FIG. 1. Furthermore, the functionality disclosed with respect to system 600 is not exclusive of the functionality of system 100. In fact, system 600 can also include all the functionality of system 100.

Here, the sender component 110 includes an interpreter generation system 610 that produces or identifies a specific implementation of interpreter component 122 or like execution environment. Subsequently, the interpreter component 122 or a representation thereof (e.g., instructions, code . . . ) can be transmitted to the receiver component 120 via the communication channel 115. This new interpreter component 122 can be installed on the receiver replacing or updating the currently installed component 122. This can correspond to or resemble upgrading receiver component firmware. Similar to transmission of inverse transforms, the interpreter component 122 can be transmitted to the receiver component 120 as data.

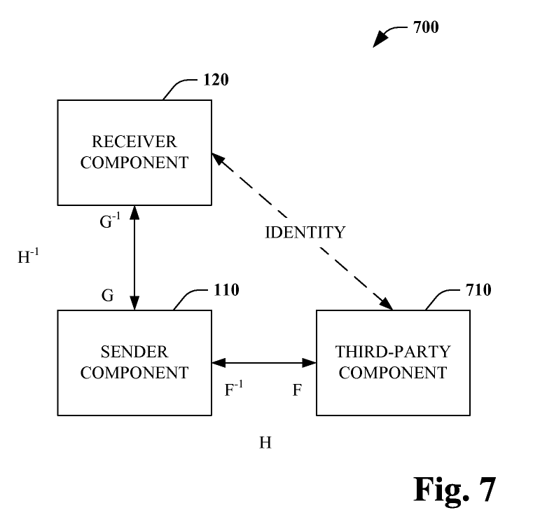

The claimed subject matter is not limited to two parties: senders, and receivers. Turning to FIG. 7, a three party communication system 700 is illustrated according to an aspect of the claimed subject matter. In addition to sender component 110 and receiver component 120, the system 700 also includes a third-party component 710 that in this exemplary case seeks to communicate with the receiver component 120 through intermediate sender component 110. For instance, there could be a firewall between the receiver component 110 and the third-party component 710.

This scenario employs transformation or function composition. Communication between the third-party component 710 and the sender component 110 utilizes application of function “F” and its inverse “F⁻¹”. Communication between the sender component 110 and the receiver component 120 includes the function “G” and its inverse “G⁻¹”. The communication of third-party component 710 and receiver component 120 through sender component 110 can be represented as “H” and an inverse “H⁻¹”. Here, however, “H” is the composition of “F” and “G” (“G(F(x)”), and the inverse is the composition of “G⁻¹” and “F⁻¹” (“G⁻¹(F⁻¹(y))”) together producing the identity function.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, transform selection component 410 can employ such mechanisms to infer an appropriate function or transform for application give a particular context.

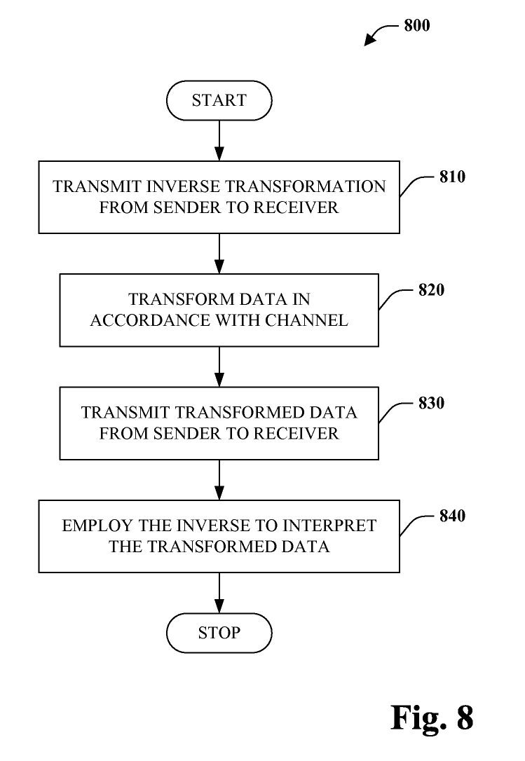

In view of the exemplary systems described supra, methodologies that may be implemented in accordance with the disclosed subject matter will be better appreciated with reference to the flow charts of FIGS. 8-11. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 8, a method of communication 800 is illustrated in accordance with an aspect of the claimed subject matter. At reference numeral 810, an inverse transform or transformation and/or identification thereof is transmitted from a sender to a receiver. For example, the sender can be a server and the receiver a client web browser. At numeral 820, one or more direct transformations are employed to convert a message targeted to one or more receivers into a form capable of being pushed through a communication channel. At reference 830, transformed data can be sent from a sender to a receiver by way of a communication channel. The inverse transformation can then be applied to the transformed data to remove the transformation and reveal the data at 840. Where the execution environments are the same, the inverse transformation and transformation pair together yield the identity function. However, where the environments are different, the inverse transform component can include functionality to produce a semantically equivalent result while altering the syntax to support a specific receiver environment. This can be the case where a server and browser execution environment or runtime are different.

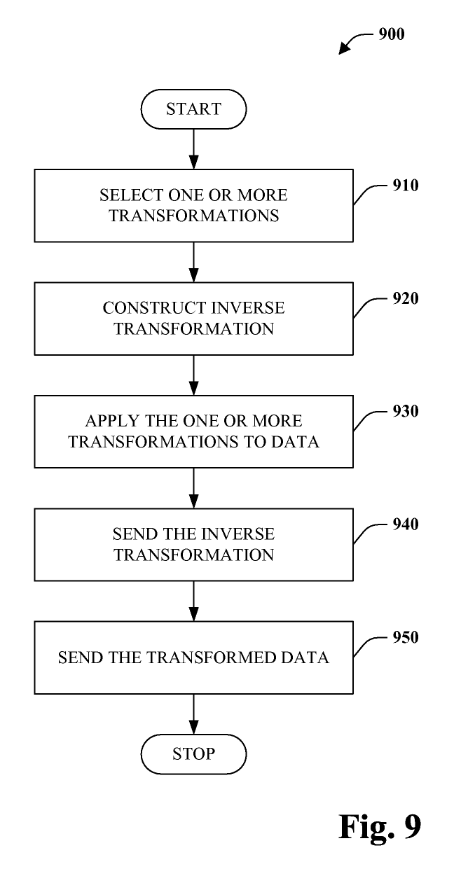

FIG. 9 depicts a method 900 of sending data in accordance with an aspect of the claimed subject matter. At reference numeral 910, one or more transformations, functions, or transformation functions are selected. A transformation transforms data from a first form to a second form. For example, data can be serialized, encrypted, or compressed, among other things. The selection itself can take into account a variety of factors including but not limited to current context and available transformations. For example, suppose it can be determined or inferred that a communication channel between a sender and receiver is vulnerable to attack and/or data is sensitive or confidential in nature. In this case, an encryption transformation can be selected. However, the exact encryption transformation can depend on those available to a receiver or user. In one instance, a default encryption transformation can be available but a better transformation can be purchased or otherwise earned by a user.

At numeral 920, an inverse transformation component can be constructed. The inverse transformation eliminates or undoes the transformation thereby making data available for processing by a receiver. Where more than one transformation is employed, more than one inverse will need to be constructed to reverse the transformation. For example, where the transformation includes two transformations encryption (“E”) and serialization (“S”), namely “S(E(x))”, the inverse would correspond to “S⁻¹(E⁻¹(x))”.

At reference 930, the one or more selected transformations can applied to data to produce transformed data (e.g., encrypted data, compressed data . . . ) Subsequently, the inverse and the transformed data can be sent or transmitted across a communication channel at reference numerals, 940 and 950 respectively.

Not only can method 900 function initially upon a first communication, it can also operate at any time throughout communication duration. In particular, applied transformation pairs can be changed upon a change in context. In one implementation, context can be evaluated at predetermined time periods to detect change. Additionally or alternatively, contextual information can be continuously monitored and transformation configuration altered upon occurrence of an event and/or a change that exceeds a threshold. For example, where bandwidth is detected or determined to be limited a different compression transformation can be employed in an attempt to counter the limited bandwidth.

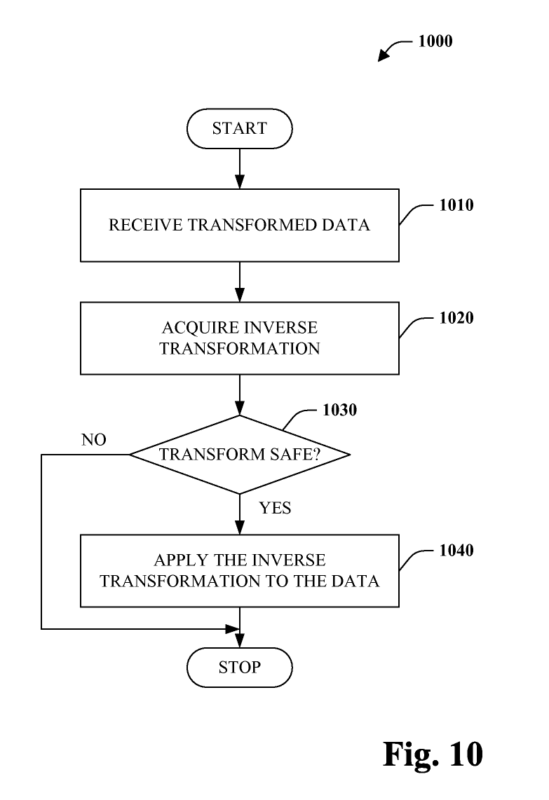

FIG. 10 is a method 1000 of receiving data according to an aspect of the claimed subject matter. At reference numeral 1010, transformed data is received. At numeral 1020, an inverse transformation or function is acquired. A determination is then made as to whether the inverse is safe at reference 1030. The inverse can be analyzed to determine if it performs any known unsafe, malicious, or computationally intense action, among other things. Additionally or alternatively, a proof associated with the inverse can be sought and analyzed to determine weather the inverse performs acceptable actions. If the inverse transformation is not safe or is otherwise unacceptable (“NO”), the method simply terminates. However, if the inverse transformation is determined to be safe or otherwise acceptable (“YES”), the inverse transformation is applied to the data to reveal data capable of being processed by the receiving entity. In any application of the inverse transformation will reveal at least semantically equivalent data to that which was sent. It should be appreciated that the inverse function need not be installed but rather simply utilized and discarded after data is received.

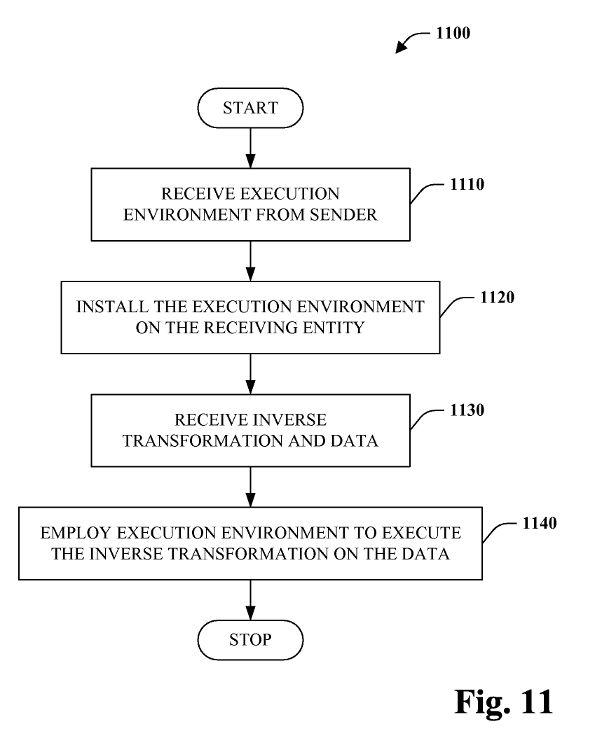

FIG. 11 is a flow chart diagram of a method 1100 of sender/receiver interaction in accordance with an aspect of the claimed subject matter. At reference numeral 1110, an execution environment for inverse transformation interpretation is received from a sender. This execution environment is installed on a receiving entity at numeral 1120. For example, a current execution environment can be updated or replaced by the newly received execution environment. At numeral 1130, transformed data and an inverse transformation are received or otherwise acquired. The execution environment is then employed at 1140 to apply the inverse transformation to the transformed data to remove the transformation. For example, serialized data can be deserialized, encrypted data can be decrypted, and/or compressed data can be decompressed.

It is to be appreciated that although transformed data and related inverse transformation as described as being separate this is not a requirement. In fact in accordance with one embodiment, a single code unit (e.g., represented as data) can capture both the inverse and the transformed data. Upon transmission to and execution by a receiver, the code unit produces untransformed data available for processing by a receiver or other associated components. In other words, execution of a function transmitted by the sender to the receiver applies the inverse transformation to the transformed data captured by the function.

Furthermore, it should be noted that in accordance with one embodiment, the inverse transformation or function provided to a receiver for utilizing need not be installed and/or hardcoded into the receiver. In fact, it can simply be utilized until it completes application to all associated transformed data. This facilitates rapid change of transformation and further provides a degree of security since a transformation such as that associated with encryption is not persisted on a store and available for continuous hacking or cracking.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

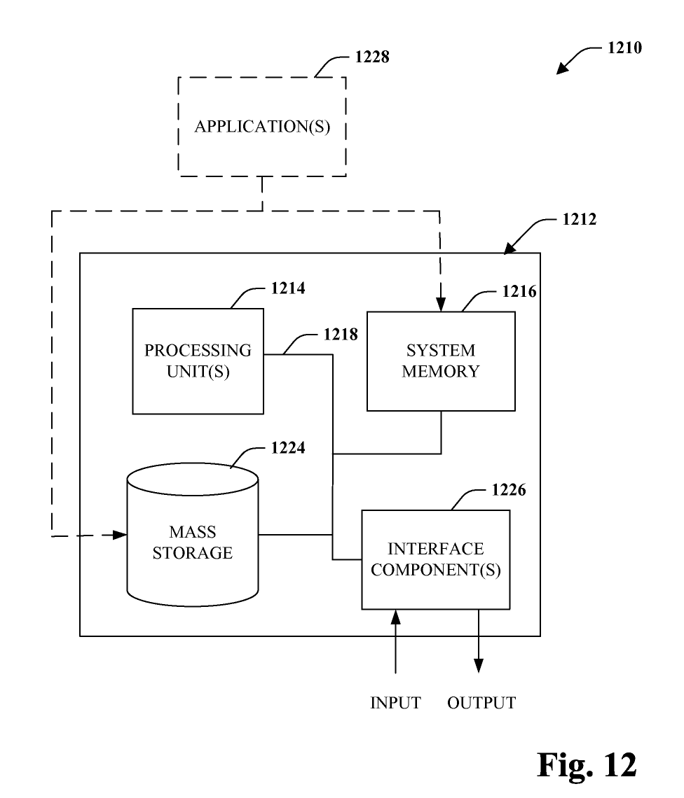

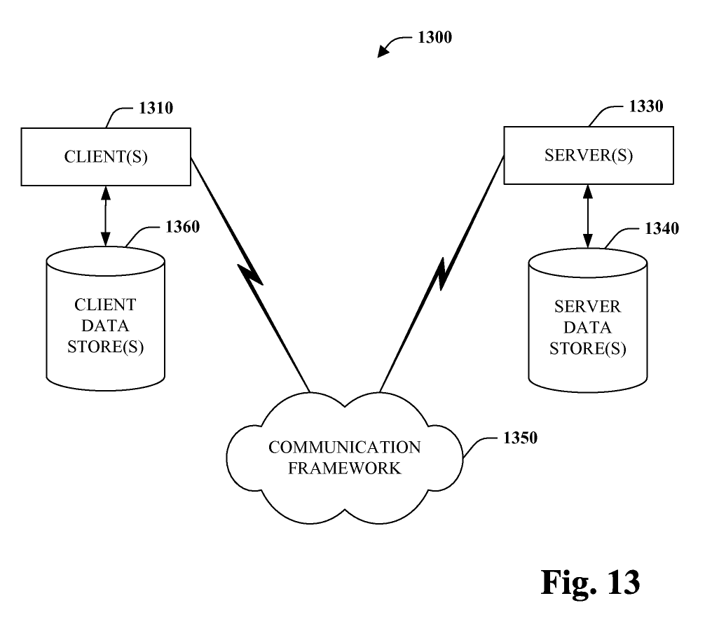

In order to provide a context for the various aspects of the disclosed subject matter, FIGS. 12 and 13 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 12, an exemplary environment 1210 for implementing various aspects disclosed herein includes a computer 1212 (e.g., desktop, laptop, server, hand held, programmable consumer or industrial electronics . . . ). The computer 1212 includes a processing unit 1214, a system memory 1216, and a system bus 1218. The system bus 1218 couples system components including, but not limited to, the system memory 1216 to the processing unit 1214. The processing unit 1214 can be any of various available microprocessors. It is to be appreciated that dual microprocessors, multi-core and other multiprocessor architectures can be employed as the processing unit 1214.

The system memory 1216 includes volatile and nonvolatile memory. The basic input/output system (BIOS), containing the basic routines to transfer information between elements within the computer 1212, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 1212 also includes removable/non-removable, volatile/non-volatile computer storage media. FIG. 12 illustrates, for example, mass storage 1224. Mass storage 1224 includes, but is not limited to, devices like a magnetic or optical disk drive, floppy disk drive, flash memory, or memory stick. In addition, mass storage 1224 can include storage media separately or in combination with other storage media.0

FIG. 12 provides software application(s) 1228 that act as an intermediary between users and/or other computers and the basic computer resources described in suitable operating environment 1210. Such software application(s) 1228 include one or both of system and application software. System software can include an operating system, which can be stored on mass storage 1224, that acts to control and allocate resources of the computer system 1212. Application software takes advantage of the management of resources by system software through program modules and data stored on either or both of system memory 1216 and mass storage 1224.

The computer 1212 also includes one or more interface components 1226 that are communicatively coupled to the bus 1218 and facilitate interaction with the computer 1212. By way of example, the interface component 1226 can be a port (e.g., serial, parallel, PCMCIA, USB, FireWire . . . ) or an interface card (e.g., sound, video, network . . . ) or the like. The interface component 1226 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 1212 to output device(s) via interface component 1226. Output devices can include displays (e.g., CRT, LCD, plasma . . . ), speakers, printers and other computers, among other things.

FIG. 13 is a schematic block diagram of a sample-computing environment 1300 with which the subject innovation can interact. The system 1300 includes one or more client(s) 1310. The client(s) 1310 can be hardware and/or software (e.g., threads, processes, computing devices). The system 1300 also includes one or more server(s) 1330. Thus, system 1300 can correspond to a two-tier client server model or a multi-tier model (e.g., client, middle-tier server, data server), amongst other models. The server(s) 1330 can also be hardware and/or software (e.g., threads, processes, computing devices). The servers 1330 can house threads to perform transformations by employing the aspects of the claimed subject matter, for example. One possible communication between a client 1310 and a server 1330 may be in the form of a data packet transmitted between two or more computer processes.

The system 1300 includes a communication framework 1350 that can be employed to facilitate communications between the client(s) 1310 and the server(s) 1330. The client(s) 1310 are operatively connected to one or more client data store(s) 1360 that can be employed to store information local to the client(s) 1310. Similarly, the server(s) 1330 are operatively connected to one or more server data store(s) 1340 that can be employed to store information local to the servers 1330.

Client/server interactions can be utilized with respect with respect to various aspects of the claimed subject matter. By way of example but not limitation the sender component 110 can correspond to the server 1330, the receiver component 120 can correspond to the client 1310, and the communication framework 1350 can correspond to the communication channel 115. Of course, this is not the only supported configuration. The reverse is also true, namely the server 1330 can be the receiver and the client 1310 the sender. Moreover, the claimed subject matter is not limited to client/server interactions. Peer-to-peer and other distributed architectures are also employable and intended to fall with the scope of the appended claims.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A distributed system, comprising:
a channel component that facilitates communication amongst parties in a specific manner;
a sender component that selects a transformation dynamically as a function of context and transmits data transformed in accordance with the selected transformation and an inverse transformation or identification thereof across the channel component; and
a receiver component acquires the data sent by the sender component from the channel component and applies the transmitted or identified inverse transformation to the data to reveal data for processing.

2. The system of claim 1, more than one transformation is applied to the data and captured by the inverse transformation.

3. The system of claim 1, further comprising a component that acquires context information including monetization scheme status, security context, processing load, power consumption, and/or communication channel context

4. The system of claim 1, further comprising a component that analyzes the inverse transformation prior to application to ensure safety.

5. The system of claim 1, further comprising an interpreter component, a representation thereof is transmitted by the sender component to the receiver component that alters the manner in which the inverse transformation is applied by the receiver component by way of the interpreter component.

6. The system of claim 5, the interpreter component is installed on the receiver component.

7. The system of claim 1, the transformed data and inverse transformation comprise a function transmitted by the sender to the receiver, execution of which applies the inverse transformation to the transformed data.

8. The system of claim 1, further comprising a third-party component that communicates with the receiver component through the sender component by way of two sets of transformations.

9. The system of claim 1, the sender component is a server and the receiver component is a web browser.

10. A method for transmitting data in a distributed system, comprising:
identifying a transformation dynamically as a function of context;
applying the transformation to data;
determining an inverse transformation to undo the transformation; and
transmitting the transformed data and inverse transformation or an identification of a standard transformation to a receiver.

11. The method of claim 10, further comprising identifying a transformation based on a monetization scheme and a status of the receiver or related user in that scheme.

12. The method of claim 10, identifying an encryption transformation as a function of the sensitivity of transmitted data and potential for a security breach.

13. The method of claim 11, further comprising identifying a compression transformation as a function of communication channel bandwidth.

14. The method of claim 10, further comprising generation a syntactically different yet semantically equivalent inverse transformation where sender and receiver execution environments differ.

15. The method of claim 10, further comprising transmitting an interpreter to the receiver that alters the manner in which inverse transformations are interpreted with respect to the transformed data.

16. A method of interacting with data in a distributed system, comprising:
receiving an inverse transformation or identification thereof and transformed data from a sender; and
applying the inverse transformation to the transformed data to reveal untransformed data.

17. The method of claim 16, further comprising evaluating the inverse transformation for safety issues and inhibiting application of unsafe inverse transformations.

18. The method of claim 16, dynamically changing application of the inverse transformation upon receipt of a second inverse transformation.

19. The method of claim 16, further comprising applying a series of inverse transformations to the transformed data.

20. The method of claim 16, further comprising acquiring and installing alternate interpreter firmware on a receiver to alter the manner in which inverse transformations are interpreted and/or applied to data.
